(19) United States
(12) Patent Application Publication
(10) Pub. No.: US 2007/0283826 A1
(43) Pub. Date: Dec. 13, 2007

(54) Synchronous flexographic printing press with fluid distribution and control system

(76) Inventor: Philip K. Morin, Bristol, CT (US)

Correspondence Address: MCCORMICK, PAULDING & HUBER LLP, CITY PLACE II, 185 ASYLUM STREET, HARTFORD, CT, 06103, US

(21) Appl. No.: 11/810,881

(22) Filed: Jun. 7, 2007

Related U.S. Application Data
(60) Provisional application No. 60/811,588, filed on Jun. 7, 2006.

(51) Int. Cl. B41F 31/00

(52) U.S. Cl. 101/350.6

(57) ABSTRACT

In a synchronous flexographic press having plural operational modes either processing or cleaning fluid is continuously pumped from a selected one of a plurality of reservoirs onto a pre-doctor blade forming a pre-doctoring nip with and terminating in inwardly spaced relation to opposite ends of an anilox roll metering surface. Fluid continuously runs off the terminal ends of the blade and into a trough at all times in gravity fluid communication with at least one of the reservoirs for return flow to a reservoir under the influence of gravity. A programmable logic controller (PLC) operates a fluid distribution valve to select the mode of operation (processing or self-cleaning) and provides appropriate response to malfunction. An impression roll, and the anilox roll are located at the same side of a vertical axial plane of the press print drum and adjacent the drum within a common angular quarter of the drum.

### CROSS REFERENCE TO RELATED APPLICATION

This application relates to Provisional U.S. patent application Ser. No. 60/811,588, filed Jun. 7, 2006, the filing date of which is hereby claimed and which application is hereby adopted by reference as part of the present disclosure.

### FIELD OF THE INVENTION

This invention relates in general to printing press technology and, more specifically, to improvements in flexographic printing presses and fluid distribution systems for presses of the afore-described type.

### BACKGROUND OF THE INVENTION

A rotary printing press of flexographic type may be characterized as having a fluid or ink metering roll or anilox roll having anywhere from 80 to over 500 engraved cells per liner inch extending over and opening through its entire cylindrical metering surface, the primary function of the anilox roll being to supply a fine film of ink to a printing plate or plates mounted to the cylindrical surface of the next roll in a sequence, the plate cylinder or print drum. However, it should be understood that such rotary machines are also employed to apply other fluids such as adhesives or coating materials to a substrate. Various applicator arrangements and fluid distribution systems are employed to ink such a metering roll surface and doctor the inked metering surface before ink carried by the surface or the cells opening through the surface of the roll is transferred to the printing plate or plates.

One type of inking system employs a fountain roll supported to rotate in a reservoir of ink to pick up and deliver a relatively heavy flow of ink from the reservoir or “fountain” and deliver it to the metering roll. The fountain roll is usually driven at a slower rate than the metering roll to provide a wiping effect on the latter roll.

In accordance with another inking arrangement, the metering or anilox roll may be positioned for direct engagement with ink in a reservoir, a doctor blade or series of doctor blades being employed to dress or doctor the metering surface before transferring a film of ink to the printing plate or plates.

Enclosed or manifold inking systems are also employed on presses of the type with which the present invention is concerned. In such a system, a portion of the metering or anilox roll and two doctor blades disposed in doctoring engagement with a segment of the metering roll surface cooperate with a box-like structure to form an enclosed fountain head for ink containment, axially oppose ends of the structure being sealed with some type of flexible sealing material to isolate the bearing housing and bearings journalled therein from contact with the ink supply. However, such systems are prone to leakage, particularly at the sealed ends, and a condition known as weeping, wherein ink seepage occurs at the bearing housing and along the roll shaft, usually resulting in ink contamination of the bearings.

Regardless of the type of system employed, the ink supply must be continuously replenished during the production cycle so that problems of production fluid overflow or leakage are ever present.

It is the general aim of the present invention to provide an improved fluid distribution and control system for a rotary press and particularly a press of the flexographic type which overcomes the aforedescribed problems and which may be programmed to compensate for certain human errors or omissions and to provide appropriate response in the event of the occurrence of certain reasonably predictable machine problems.

### SUMMARY OF THE INVENTION

In accordance with the present invention a flexographic printing press has a metering or anilox roll journalled for rotation in the machine about a horizontally disposed axis and which includes a coaxially generally cylindrical metering surface. An improved doctor blade assembly embodying the present invention forms a part of a fluid distribution and control system in accordance with the present invention. The doctor blade assembly has a shallow elongated longitudinally extending trough for mounting on the press generally below and in fixed position relative to the metering roll. A pre-doctor blade mounted in fixed position on an upper portion of the trough is downwardly inclined in the direction of the roll and defines a pre-doctoring edge disposed in pre-doctoring relation to the metering roll surface and extends along a substantial portion of the metering roll surface being terminated at each of its ends by an associated termination edge which extends generally transversely of an intersects the pre-doctoring edge and terminates it at a point of termination spaced axially inwardly for some distance from an associated end of the metering roll surface. The pre-doctor blade cooperates with a portion of the cylindrical metering surface in the region of a nip therebetween to define a fluid receiving space which opens outwardly and into the trough at the points of termination and along the terminal edges. A fluid inlet port opens into the trough above the nip. The trough also has an upwardly facing bottom surface and at least one fluid outlet port which opens through the bottom surface.

### BRIEF DESCRIPTION OF THE DRAWINGS

FIG. 1 is a schematic side elevational view of a flexographic printing press in accordance with the present invention.

FIG. 2 is a somewhat enlarged perspective view of the doctoring blade assembly of the machine of FIG. 1.

FIG. 3 is a somewhat further enlarged sectional view taken along the line 3, 3 of FIG. 2 shown with the anilox roll in doctoring position.

FIG. 4 is a somewhat enlarged sectional view taken along the line 4, 4 of FIG. 2.

FIG. 5 is a sectional view taken generally along the line 5, 5 of FIG. 3 and shows the doctoring position of the pre-doctor blade and the doctor blade relative to the anilox roll surface.

FIG. 6 is a diagrammatic view illustrating the fluid recirculation system.

### DETAILED DESCRIPTION OF PREFERRED EMBODIMENT

Synchronous Web Drive

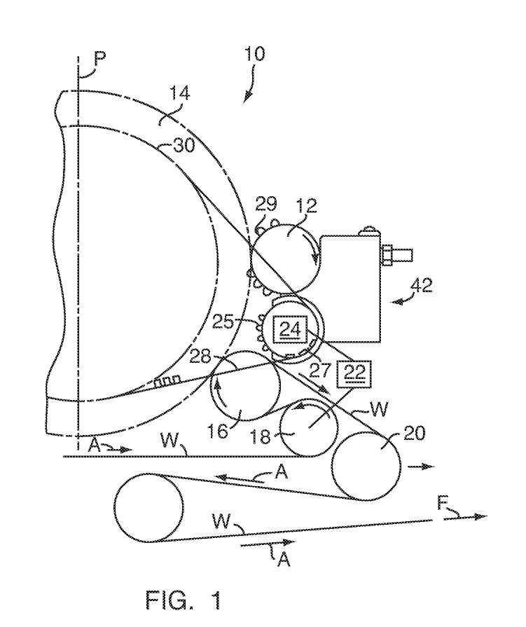

In the drawings and in the description which follows, the present invention is illustrated and described with reference to a synchronous flexographic printing press embodying the present invention, shown somewhat schematically in FIG. 1, and indicated generally by the reference numeral 10. The illustrated machine 10 comprises a flexographic printing press, characterized by an inking system which includes a metering or anilox roll indicated at 12. The illustrated rotary press 10 also has a print drum 14 and an impression roll 16, as is characteristic of flexographic printing machines.

In the flexographic printing process, the impression roll, the anilox roll and the print drum must each have a surface speed exactly equal to the linear speed of the web. If any one of these rolls is traveling at a slightly different circumferential surface rate than the others, there will be severe printing problems as well as excessive printing plate wear. The present synchronous web advancing system hereinafter further described overcomes these problems.

The machine 10 further includes an encoder roll 18 and a tension roll 20. Each of the rolls 12 and 16-20 are supported at the forward end of the printing press 10, preferably generally ahead of the print drum, being arranged in the machine 10 in axially parallel relation to the print drum 14, substantially as shown in FIG. 1, where the path of travel of a web of paper W is shown and indicated by directional arrows designated by the letters A,A.

Pulling force for advancing the web W within and through the machine 10 is provided by another separate and distinct machine (the host machine) (not shown) located some distance forward to the machine 10. The host machine may, for example, comprise a labeler for applying to a packaged product printed package labels, produced by the machine 10. The direction of the force applied to the web by the host machine is indicated by the letter F in FIG. 1.

Further considering the path of travel of the web W, the web is drawn from a supply roll (not shown) and travels in a reversing S-shaped curve under, around and over the encoder roll 18, and under, around and over the impression roll 16, which is journalled for free rotation within the machine 10. The web W travels from the impression roll 16 to and over the tension roll 20, which is spring biased to apply tension to the advancing web W.

The pulling force F for withdrawing the web W from the machine 10 causes the tension roll to maintain tension on the web so that the encoder roll 18 and the impression roll 16 move at a circumferential speed which matches the linear speed of the web W as it leaves the machine 10. A rotary encoder 22 directly coupled to the shaft of the encoder roll 18 outputs electrical pulses directly to either a servo motor or stepping motor 24 to energize the latter drive motor.

A drive gear 25 and a timing belt pulley 27, coaxially mounted on and keyed to the driveshaft of the drive motor 24, drive another gear 29 associated with the anilox roll 12 and a timing belt 28 connected to a drum sprocket 30 on the print drum 14 to drive the anilox roll and the print drum, respectively. The anilox roll has a 1 to 1 ratio with respect to the impression roll 16 and a 5 to 1 ratio with respect to the print drum 14. Thus, while the aforedescribed encoder-drive arrangement does not drive the paper through the printing machine 10, it does maintain precise synchronization between the various machine components and the web as the web of paper or other material travels through the flexographic printer 10 in response to the pulling force F applied to the web W by the host machine.

In flexographic printing presses of the prior art, the anilox and impression rolls are generally located operatively adjacent the print drum and at opposite sides of a vertical axial plane of the drum. It should be noted that in accordance with the present invention, both the anilox roll 12 and the impression roll 16 are located on the same side of a vertical axial plane of the print drum, shown in FIG. 1 and indicated by the letter P, rolls 12 and 16 being located proximate the forwardly facing surface of the print drum.

In the present machine, the latter two rolls are generally located within a common angular quarter of the print drum. Thus, at least three-quarters of the circumferential surface of the print drum is free of obstruction and may be utilized to carry a printing plate or plates. In flexographic machines of the prior art, the positions of the metering roll and the impression roll relative to each other and to the print drum may make it necessary to provide a larger print drum when the length of the image to be printed is increased in a circumferential direction. A machine in accordance with the present invention avoids this print drum enlargement problem by providing for more effective utilization of a smaller print drum. This arrangement enables a machine to accommodate larger work such as a single larger image or a series of images, as, for example, a series of product labels without the necessity for increasing the size of the print drum and the machine.

The arrangement of the anilox roll 12, the print drum 14 and the impression roll 16 in relatively close proximity to each other and at the front end of the machine 10 allows for easy access to these essential machine components to facilitate convenient machine servicing, when necessary.

Fluid Distribution and Control

The primary function of machines of the type with which the present invention is concerned is printing, however, such machines are capable of and are frequently used for processes in which fluids other than inks are applied to a substrate, as, for example, in the application of liquid adhesive compounds and coating materials. Such machines are also used in self-cleaning operations wherein the fluid distributed to the machine is an appropriate machine cleaning solution and such self-cleaning operations are contemplated within the scope of the present invention.

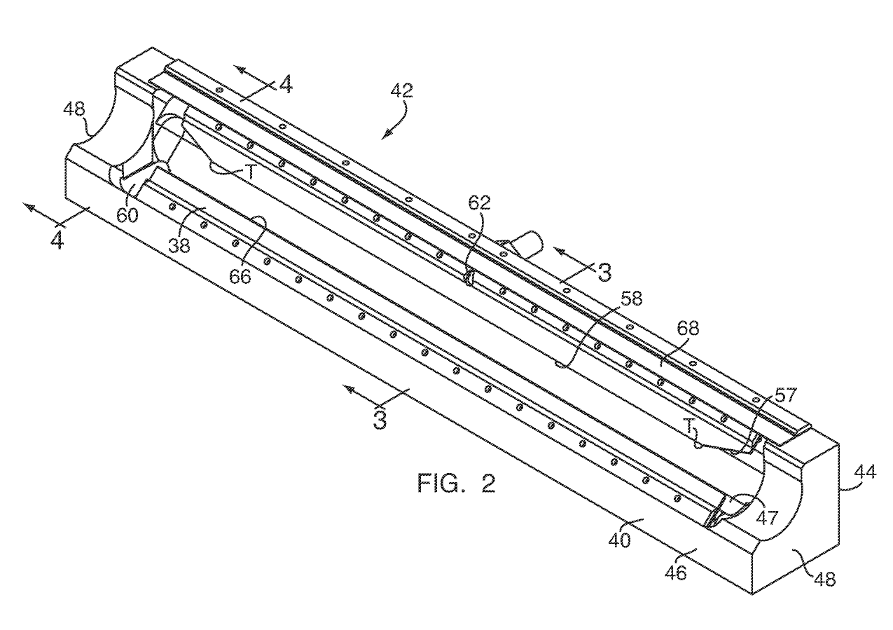

In accordance with the present invention, the fluid distribution and control system for the machine 10 essentially comprises a doctor blade assembly, indicated generally at 42 in FIGS. 2-4, which includes a pre-doctor blade 36, a doctor blade 38 and elongated, shallow trough, indicated generally at 40, connected to a fluid recirculation system hereinafter further described. The pre-doctor blade 36 and the doctor blade 38 are mounted in fixed position on the trough 40 to cooperate with the metering or anilox roll 12, which is carried by a bearing housing slidably supported on the machine frame. The slidably mounted bearing housing also carries the doctoring blade assembly 42 and allows for adjustment of the anilox roll 12 relative to the print drum 14. The doctor blade assembly 42 is preferably clamped to the bearing housing to facilitate removal from the machine 10 for servicing when and as necessary.

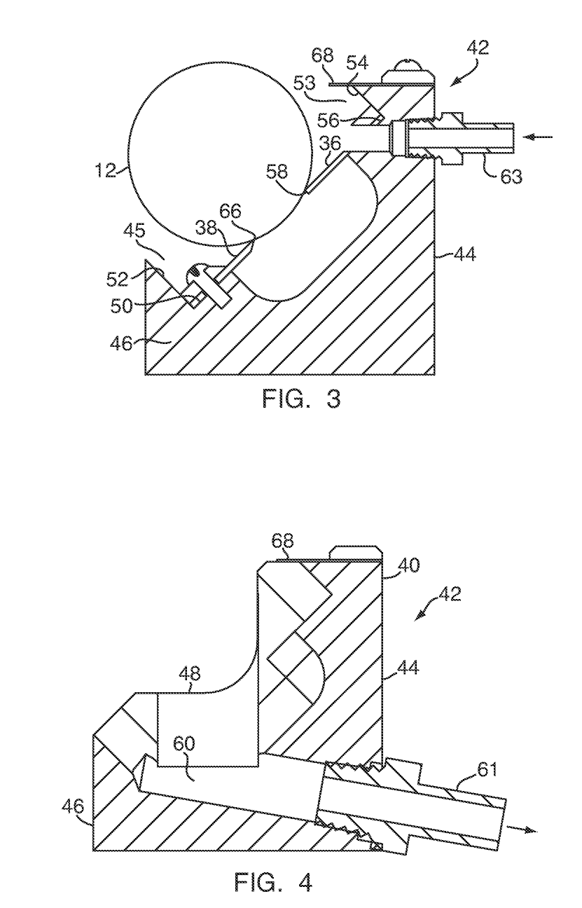

Referring now to FIGS. 2-5, the trough 40 is preferably formed from metal, has a generally L-shaped cross section, and includes a front wall 44, a bottom wall 46, and opposing generally L-shaped side walls 48,48 which extend for some distance rearwardly of the front wall 44 and above the bottom wall 46. The bottom wall 46 is generally horizontally disposed when the machine 10 is in set up condition, and has an upwardly facing upper surface 47 which may be slightly downwardly and outwardly inclined from at central portion of the bottom wall and toward the side walls 48,48. The bottom wall 46 has a generally upwardly open V-shaped groove 45, defined by surfaces 50 and 52, as best shown in FIG. 3, and which extends along a substantial portion of the bottom wall 46 between the end walls 48,48 to accommodate the doctor blade 38. In like manner, the front wall 44 has a generally rearwardly open V-shaped groove 53 formed therein by generally rearwardly facing surfaces 54 and 56, and which extends for a substantial distance along the front wall 44 between the side walls 48,48 to accommodate the pre-doctor blade 36 (FIG. 3).

Outlet ports 60,60 formed in the bottom portion of the trough 40 open outwardly through a frontal surface of the front wall 44 and upwardly through the bottom wall surface 47 adjacent each of the end walls 48,48. A portion of each outlet port 60, which opens through the frontal surface of the front wall, is internally threaded to receive a threaded fitting on a fluid outlet conduit 61, as shown in FIG. 4.

A fluid inlet port 62 is formed in the central upper portion of the front wall 44 to communicate with the interior of the trough and opens outwardly through the frontal surface of the front wall and inwardly through the rearwardly facing groove 53. The outer portion of the inlet port 62 is internally threaded to receive a fitting on a fluid inlet conduit 63. It should be noted that the inlet port 62 is substantially smaller than each of the outlet ports 60,60 and the fluid outlet conduit 61.

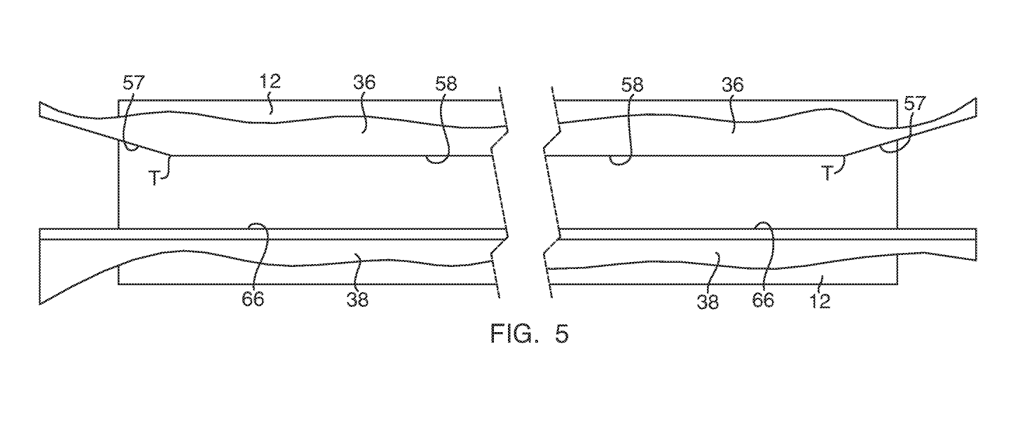

The pre-doctor and doctor blades used in practicing the present invention may be made from any suitable blade material; however, in accordance with present preference, the upper or pre-doctor blade 36 is formed from a polyester blade material and the lower or doctor blade 38 is made from DELRIN® (a plastic material). The pre-doctor blade 36 is supported on the front wall 44 within the rearwardly facing groove 53, rests upon the surface 56 and defines a portion of the fluid inlet port 62. An elongated blade holder overlies a portion of the outer surface of the blade 36 and is mounted on the front wall 44 by a longitudinally series of spaced apart threaded fasteners which firmly secure the blade 36 at spaced intervals along its entire length. In accordance with the invention, the pre-doctoring edge of blade 36, indicated at 58, has a horizontal length which is less than the axial length of the cylindrical metering surface of the anilox roll 12. Each terminal end of the pre-doctoring edge 58 is spaced inwardly for some distance from an associated end of the metering surface of the anilox roll 12. The opposite ends of the pre-doctoring edge 58 are terminated by terminal edges of the pre-doctoring blade 36. The terminal edges, indicated at 57,57, are bias cut relative to the doctoring edge 58 to intersect and thereby terminate the blade edge 58 at points of termination indicated by the letters T, T as best shown in FIG. 5. The particular shape and directions of extent of the terminal edge portions 57,57 of the blade 36 are not critical. However, it is important that the effective length of the pre-doctoring edge 58 be shorter than the axial length of the metering surface of the anilox roll 12.

As previously noted, the doctor blade 38 has a length which is preferably greater than the axial length of the anilox roll metering surface so that the doctoring edge 66 extends across the entire length of the anilox roll when the doctor blade 38 is in doctoring position relative to the roll 12. Referring now to FIG. 5, the effective lengths of the pre-doctor blade edge 58, the doctor blade edge 66 and the metering surface of the anilox roll 12 are shown.

The doctor blade 38 is received within the upwardly open groove 45, and extends along the groove in overlying relation to the surface 50. The doctor blade 38 is secured to the trough bottom wall by an elongated overlying blade holder, which defines a portion of the inlet port 62, and is fastened to the trough by a longitudinal series of threaded fasteners in much the same manner in which the pre-doctor blade 36 is secured to the trough.

In accordance with the invention, the doctor blade assembly 42 includes a blade-like splash guard 68 mounted on and extending along the upper surface of the front wall 44. The splash guard 68 is horizontally disposed, projects rearwardly from the front wall in upwardly spaced relation to the pre-doctor blade 36 and extends along the front wall in a direction generally parallel to the direction of extent of the pre-doctor blade. It is preferably made from a plastic material.

The previously described inlet port 62 opens inwardly through a central portion of the pre-doctor blade 36 and through its blade holder above the pre-doctoring edge of the blade 36 and substantially immediately below the splash guard 68, as best shown in FIGS. 2 and 3.

When the machine 10 is properly set up, the axis of each of its operating rolls is horizontally disposed. The doctor blade assembly 42 is releaseably secured in fixed position relative to the frame of the machine on the bearing housing and in its operative position of FIG. 1 in which position the opposing doctoring blades 36 and 38 lie within a substantially common plane which forms an angle of about 45 degrees with the horizontal, as best shown in FIG. 3.

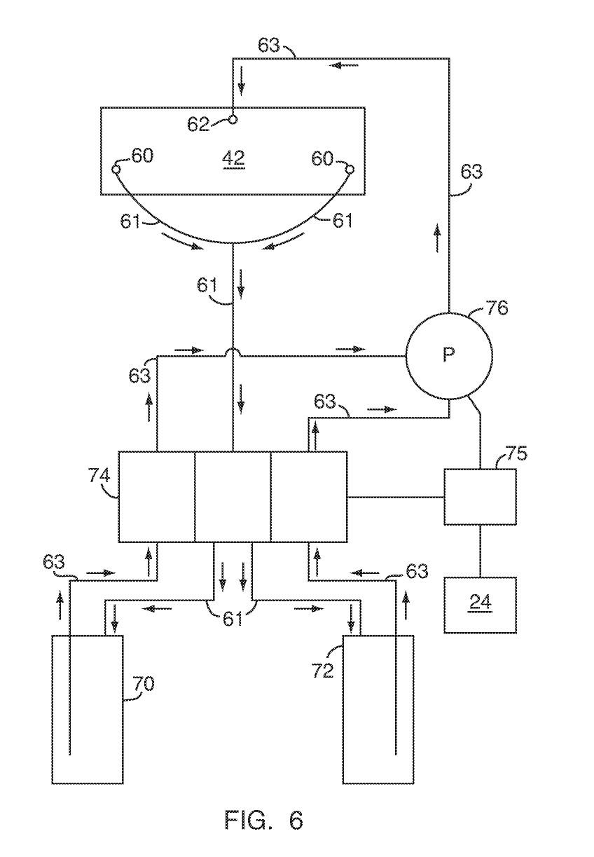

The illustrated machine 10, as hereinafter further described, is particularly adapted for operation with at least two different fluids and in a selected one of at least two possible modes of operation. For example, fluid ink is employed when the machine is operated in its printing mode, and a cleaning solution compatible with the ink is used when the machine is operated in its cleaning mode. The fluid recirculation system, shown in FIG. 6, includes a first reservoir 70 for containing a quantity of ink and a second reservoir 72 which holds a quantity of the cleaning solution. The system further includes a control valve or spool valve 74 having two valve spools, one spool associated with the trough inlet port 62 for selectively controlling the fluids supplied to that port and the other spool associated with the trough outlet ports 60,60 for selectively controlling the gravity discharge of fluid from the trough for return to its respectively associated fluid reservoir. The system also includes a controller, the presently preferred controller being a programmable logic controller (PLC) 75 programmed to control the fluid distribution cycle. A manual override control 77 is also provided to allow the machine operator to override the programmed machine cycle, as will be hereinafter discussed. A common pump 76, preferably of a peristaltic type, is connected in the fluid delivery or inlet conduit 63 and is used to pump either ink or cleaning solution from a respectively associated one of the two reservoirs 70 and 72 and deliver it to the doctor blade assembly 42 through the fluid inlet conduit 63 and the inlet port 62.

The pump 76 operates continuously to recirculate fluid while the machine 10 is operating in either its printing or cleaning mode. The valve spool which controls the discharge of fluid from the trough 40 of the doctor blade assembly 42 is normally open to allow gravity flow of fluid from the trough 40 to the one or the other of the two reservoirs 70 and 72 so that the fluid being used, i.e. ink or a cleaning fluid, is returned to its proper reservoir for recirculation. It should be noted, however, that the valve spool which controls the fluid return portion of the cycle is at all times open to allow free flow of fluid to one or the other of the two reservoirs or simultaneously to both reservoirs so that the discharge ports 60,60 are at all times in communication with one or the other of the reservoirs and for a very short interval of time in communication with both of the fluid reservoirs. Thus, by providing for an “overlap” in the closing of the valve ports associated with the valve spool which controls the gravity discharge of fluid from the doctor blade assembly, the risk of trough overflow in the event of valve malfunction, for example, is wholly eliminated. While such a failure in the recirculation system could cause ink contamination resulting in some loss of the ink supply, the financial loss caused by the loss of a quantity of ink is minuscule as compared to the consequential damages such as loss of production and down time for machine cleanup should trough overflow occur.

If the press 10 is to print in two or more colors, spool valves, for example, may be ganged as necessary, or a larger valve having additional spools may be provided for a multi color mode of operation.

During normal operation of the machine 10, fluid is pumped into the doctor blade assembly 42 through the inlet conduct 63 and the fluid inlet port 62 and onto the pre-doctor blade and into the open ended space between the pre-doctor blade 36 and the anilox roll 12. The nip formed between the pre-doctoring edge 58 of the blade 36 and the rotating anilox roll 12 forces ink into the cells of the anilox roll filling these cells for ink transfer from the anilox roll 12 to the substrate provided by the web W. Excess ink flows along the upper surface of the pre-doctor blade 36 and outwardly through the spaces at the opposite open end of the blade 36 so that the blade ceases to co-act with the anilox roll at the points of termination T, T. The excess ink flows over the cut-off or 57, 57 which terminate the pre-doctoring edge 58. This excess ink flows more or less directly off the pre-doctor blade ends 57, 57 and into the discharge ports 60,60 for substantially immediate return to the ink reservoir by the return gravity flow conduit system. The relatively small quantity of ink removed from the anilox roll by the doctor blade 38 is captured by the trough 40 and flows along the bottom surface 47 of the trough to one or the other of the two outlet ports 60,60 at the opposite ends of the trough for a substantially immediate return gravity flow to the ink reservoir. Thus, problems of ink leaking, ink spillage, shaft weepage and bearing contamination are overcome by the present invention. It will also be noted that by minimizing the exposure of the ink to atmosphere, little or no evaporation occurs, which effectively stabilizes ink pH and viscosity.

When the web stock runs out of the printer 10, as, for example, at the end of a work shift, the machine will continue to pump ink for a predetermined short interval of time after which the (PLC) 75 will signal to shift the spools of the spool valve 74 so that the supply conduit no longer receives ink but now receives cleaning liquid. The PLC is programmable to supply electrical pulses to the drive motor 24 to maintain operation of the anilox roll 12 and the print drum 14 in the absence of a web pulling force supplied by a host machine. It should be noted that at all times the return conduit remains connected to one or the other or both of the ink supply reservoir and the cleaning fluid supply reservoir so that the trough 40 is always in a drain mode due to the slight drainage overlap provided by the spool valve 74. The printing press 10 continues to run during the cleaning cycle. Cleaning liquid is picked up by the anilox roll which cleans the cells in that roll and is or may be also transferred by the anilox roll to the printing plate or plates on the print drum to dean those plates. After a predetermined cleaning period the printing machine will be shut down by the (PLC).

The manual override allows the printing machine operator to immediately activate the cleaning cycle at the end of a work shift. However if the operator forgets to shut down the processing mode and activate the cleaning cycle the cleaning cycle will be activated by the (PLC) after a predetermined elapsed time. This arrangement prevents the machine from running “dry” over a weekend, for example, which would be likely to damage the expensive anilox roll and the printing plate or plates as well.

The spool valve used in practicing the present invention is in many respects of conventional construction in that it has a valve body containing a pair of axially parallel generally cylindrical spools and conventional inlet, outlet and control ports, the present valve being pneumatically controlled. The value is a two-position value, each of the spools being arranged to shift in an axial direction between its two positions. However, one of the spools has overlapping porting so that one or the other, or both ports are in open condition at all times to allow for the passage therethrough of a least some fluid at all times.

Each of the spools is made in three parts, includes a central part and two end parts, and carries two split metal sealing rings. The two end parts are removable from the central part of the spool to allow for assembly of the rings with the spool. Each end part of the spool carries an elastomeric cup seal and an elastomeric o-ring to provide a seal for cooperating with a pneumatic operator for the valve.

What is claimed is:

1. In a flexographic printing press having an axially elongated generally cylindrical metering roll supported for rotation on the press and about a horizontally disposed axis and defining a coaxial generally cylindrical metering surface, and a fluid distribution system for supplying fluid to said metering roll, the improvement wherein said fluid distribution system comprises: a longitudinally elongated shallow trough supported on said press in fixed relation to and generally below said metering roll in longitudinal parallel alignment with said axis, a longitudinally elongated pre-doctor blade mounted in fixed position on said trough and downwardly inclined in the direction of said metering surface and having a pre-doctoring edge extending along a substantial portion of said metering surface in pre-doctoring relation to said surface and parallel relation to said axis, said pre-doctoring blade having terminal edges at opposite end portions thereof intersecting and terminating said pre-doctoring edge at points of termination, each point of termination being axially inwardly spaced for some distance from an associated end of said metering surface, said pre-doctoring blade cooperating with an associated portion of said metering surface to define a nip and an upwardly open space above said nip and opening outwardly at said terminal edges, said trough defining a fluid inlet port above said space and a fluid outlet port generally below said nip for the gravity flow of fluid from said trough.

2. In a flexographic printing press as set forth in claim 1 the further improvement wherein said outlet port is substantially larger than said inlet port.

3. In a flexographic printing press as set forth in claim 1 the further improvement wherein said terminal edges are biased relative to said pre-doctoring edge.

4. In a flexographic printing press as set forth in claim 1 the further improvement wherein said doctor blade assembly includes a doctor blade mounted in fixed position on a lower portion of said trough and having a doctoring edge extending along the entire axial length of said metering surface in parallel relation to said axis and in doctoring relation to said metering surface.

5. In a flexographic printing press as set forth in claim 4 wherein said doctor blade is further characterized as a reverse doctor blade.

6. In a flexographic printing press as set forth in claim 5 wherein said pre-doctor blade and said doctor blade are generally disposed within a common plane with said pre-doctoring edge and said doctoring edge in spaced apart opposition to each other.

7. In a flexographic printing press as set forth in claim 6 the further improvement wherein said common plane forms an angle of approximately 45 degrees with the horizontal.

8. In a flexographic printing press as set forth in claim 1 the further improvement wherein said doctor blade assembly includes a longitudinally elongated generally horizontally disposed splash guard mounted in fixed position on an upper portion of said trough in generally longitudinally parallel relation to said axis and above said inlet port.

9. A flexographic printing press having a print drum journalled for rotation about a horizontal axis and including a coaxial cylindrical drum surface, an anilox roll journalled for rotation about a horizontal axis and disposed generally adjacent said drum surface, and an impression roll journalled for rotation about a horizontal axis generally adjacent said drum surface, said anilox roll and said impression roll being positioned at the same side of a vertical axial plan of the print drum.

10. A flexographic printing press as set forth in claim 9 wherein said anilox roll and said impression roll are disposed within a common angular one quarter of said print drum.

11. A flexographic printing press as set forth in claim 10 wherein said anilox roll and said impression roll are disposed at the forward end of the press.
